(19) United States
(12) Patent Application Publication
(10) Pub. No.: US 2026/0370955 A1
(43) Pub. Date: Nov. 19, 2026

(54) IMAGE CAPTURING CONTROL APPARATUS, IMAGE PROCESSING APPARATUS, IMAGE CAPTURING APPARATUS, DRIVING METHOD OF IMAGE SENSOR, EQUIPMENT, AND NON-TRANSITORY COMPUTER-READABLE STORAGE MEDIUM

(71) Applicant: CANON KABUSHIKI KAISHA, Tokyo (JP)

(72) Inventor: TOSHIYUKI FUKUI, Kanagawa (JP)

(21) Appl. No.: 19/743,669

(22) Filed: Jul. 16, 2026

Related U.S. Application Data
(63) Continuation of application No. PCT/JP2025/000617, filed on Jan. 10, 2025.

(30) Foreign Application Priority Data
Jan. 22, 2024 (JP) 2024-007546

(51) Int. Cl. H04N 23/73; H04N 23/72; H04N 23/741; H04N 23/745

(52) U.S. Cl. CPC H04N 23/73; H04N 23/72; H04N 23/741; H04N 23/745

(57) ABSTRACT

An image capturing control apparatus that causes an image sensor, which includes a plurality of pixel blocks each including a plurality of pixels, to capture a moving image. The image capturing control apparatus comprises a control unit configured to control the image sensor such that one frame period in the moving image includes: a first image-capturing period including a charge accumulation time period controlled based on a first exposure condition determined for each of the plurality of pixel blocks; and a second image-capturing period including a charge accumulation time period based on a predetermined second exposure condition.

### CROSS-REFERENCE TO RELATED APPLICATIONS

This application is a Continuation of International Patent Application No. PCT/JP2025/000617, filed Jan. 10, 2025, which claims the benefit of Japanese Patent Application No. 2024-007546, filed Jan. 22, 2024, both of which are hereby incorporated by reference herein in their entirety.

### BACKGROUND

### Field of the Technology

The present disclosure relates to an image capturing control apparatus, an image processing apparatus, an image capturing apparatus, a driving method of an image sensor, equipment, and a non-transitory computer-readable storage medium.

### Description of the Related Art

In order to widen the dynamic range of an image capturing apparatus, a method of partially changing the exposure of an image sensor has been proposed. PTL 1 discloses that the entire light receiving region of an image sensor is divided into a plurality of regions, and the exposure time period, which is the charge accumulation time period in the sensor, and the amplification gain for an analog signal from the sensor are set for each region. PTL 2 describes a technique in which the sensitivity and exposure are set for each region, and the exposure time period is increased when capturing a light source having flicker.

### CITATION LIST

### Patent Literature

PTL 1: Japanese Patent Laid-Open No. 2021-129144

PTL 2: Japanese Patent Laid-open No. 2023-14831

### SUMMARY

The present disclosure provides a technique that enables wide dynamic range image capturing by setting region-based exposure conditions while reducing the influence of flicker on image capturing.

According to one aspect of the present disclosure, there is provided an image capturing control apparatus that causes an image sensor, which includes a plurality of pixel blocks each including a plurality of pixels, to capture a moving image, the apparatus comprising a control unit configured to control the image sensor such that one frame period in the moving image includes: a first image-capturing period including a charge accumulation time period controlled based on a first exposure condition determined for each of the plurality of pixel blocks; and a second image-capturing period including a charge accumulation time period based on a predetermined second exposure condition.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram showing an example of the schematic configuration of an image capturing apparatus and its connection with a controller;

FIG. 2 is a view for explaining an image sensor;

FIG. 3 is a block diagram showing an example of the configuration of an exposure compensation unit;

FIG. 4 is a view showing the relationship between control of the exposure time period and the emission cycle of a light-emitting source included in the image capturing target;

FIG. 5 is a table showing the relationship among the exposure condition, the exposure time period, and the analog gain in region-based exposure control;

FIG. 6 is a view showing the relationship between control of the exposure time period and the emission cycle of a light-emitting source included in the image capturing target in the second embodiment;

FIG. 7 is a block diagram showing an example of the configuration of an exposure compensation unit in the third embodiment;

FIG. 8 is a flowchart illustrating the processing procedure of a flicker determination unit in the third embodiment;

FIG. 9 is a block diagram showing an example of the schematic configuration of an image capturing apparatus and its connection with a controller in the third embodiment;

FIG. 10 is a flowchart illustrating the processing procedure of an image adding unit in the third embodiment;

FIG. 11 is a view showing the relationship between control of the exposure time period and the emission cycle of a light-emitting source included in the image capturing target in the fourth embodiment;

FIG. 12 is a block diagram showing an example of the schematic configuration of an image capturing apparatus and its connection with a controller in the fourth embodiment; and

FIG. 13 is a view showing an application example of the image capturing apparatus to equipment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

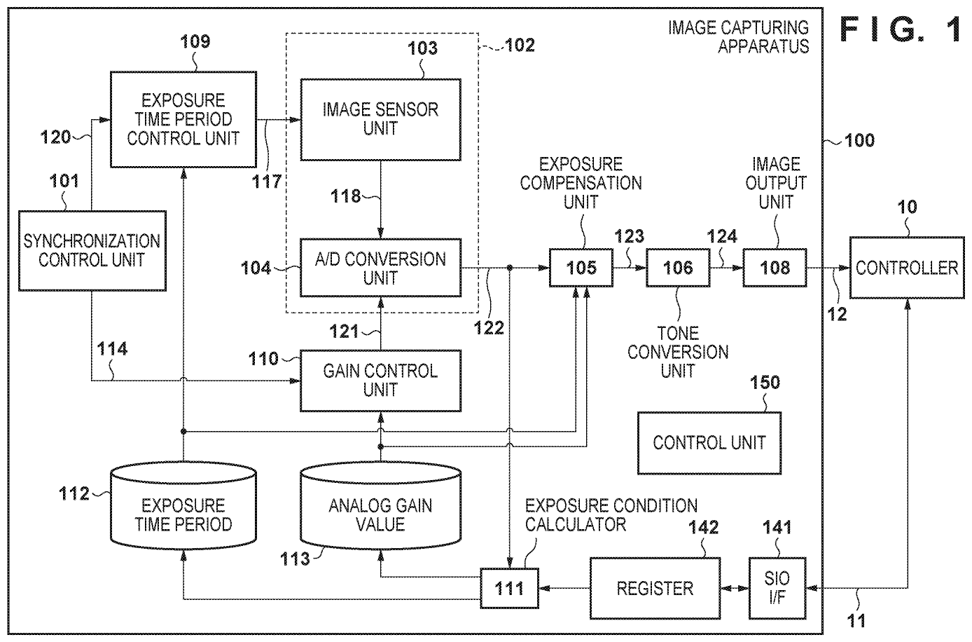

FIG. 1 is a block diagram showing an example of the schematic configuration of an image capturing apparatus 100 to which an image capturing control apparatus according to this embodiment is applied, and its connection with a controller 10. Although the image capturing apparatus 100 according to this embodiment also includes various kinds of components of a general image capturing apparatus, for the sake of illustrative and descriptive simplicity, FIG. 1 shows only main constituent parts according to this embodiment. Note that the constituent parts described below are merely examples. The functions of the constituent parts described later may be combined into one or may be separated, as appropriate. Alternatively, one constituent part may also perform the function of another constituent part. It is also possible to provide the constituent part outside the image capturing apparatus 100, for example, in the controller 10.

The image capturing apparatus 100 according to this embodiment can include a synchronization control unit 101, an image sensor unit 103, an A/D conversion unit 104, and an exposure compensation unit 105. The image capturing apparatus 100 can further include a tone conversion unit 106, an image output unit 108, an exposure time period control unit 109, a gain control unit 110, an exposure condition calculator 111, and a control unit 150.

Each of the synchronization control unit 101, the exposure time period control unit 109, and the gain control unit 110 can be an image capturing control apparatus that controls image capturing. The image capturing control apparatus can include at least one of the synchronization control unit 101, the exposure time period control unit 109, and the gain control unit 110. Each of the exposure compensation unit 105 and the tone conversion unit 106 functions as an image processing apparatus that performs image processing on an exposure image 122. The image processing apparatus can include at least one of the exposure compensation unit 105 and the tone conversion unit 106. The image capturing apparatus 100 can also include the control unit 150 that controls the image capturing apparatus 100. The control unit 150 may be provided in each unit of the image capturing apparatus 100, or may control part or all of the image capturing apparatus 100.

An exposure time period 112 and an analog gain value 113 can be set for the image capturing apparatus 100. The image sensor unit 103 includes a photoelectric conversion element that converts light into a charge and accumulates it. The image capturing apparatus 100 also includes a serial input/output interface (SIO I/F) 141 and a memory or register 142 to reflect the settings provided from the controller 10 outside the image capturing apparatus 100. An image sensor 102 can include the image sensor unit 103 and the A/D conversion unit 104. In this embodiment, the image capturing apparatus 100 can be connected to the external controller 10 via a serial communication line 11 and an output signal line 12.

The outline of each constituent part of the image capturing apparatus 100 will be described, starting from the image sensor unit 103. The image sensor unit 103 includes an imaging region (light receiving region). The imaging region is divided into a plurality of regions called pixel blocks. The image sensor unit 103 can be driven on a pixel block (region) basis, and has a function of performing an exposure operation (charge accumulation) according to a different exposure time period for each region. Here, the exposure time period corresponds to a charge accumulation time period during which the photoelectric conversion element accumulates charges. The exposure operation corresponds to accumulating charges.

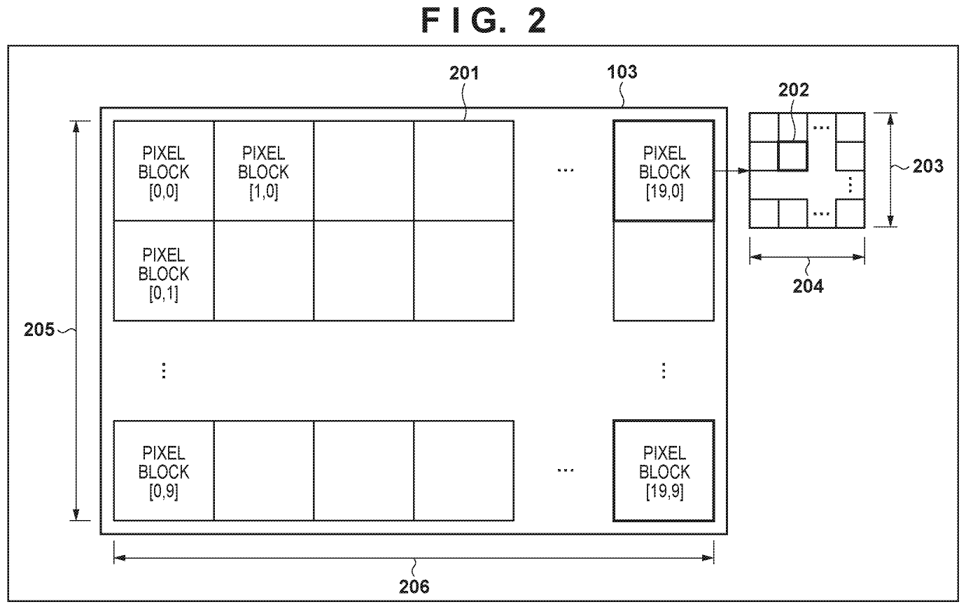

The pixel block will be described later with reference to FIG. 2. The pixel block includes a plurality of pixels. A plurality of pixel blocks are arranged in the image sensor unit 103. In this embodiment, in the image sensor unit 103, the charge accumulation time period for accumulating charges is set for each pixel block region according to an exposure control signal 117 supplied from the exposure time period control unit 109. The image sensor unit 103 performs exposure according to the charge accumulation time period set for each region. The exposure time period control unit 109 controls the image sensor unit 103. Note that the charge accumulation time period can be called the exposure time period since it is the time period associated with image capturing.

The exposure control signal 117 is a signal for setting a region-based exposure time period with respect to each region of the image sensor unit 103. The image sensor unit 103 reads out, as a pixel potential 118, the charges accumulated in each pixel during the exposure time period, which is set for each region according to the exposure control signal 117, and outputs the pixel potential 118 to the A/D conversion unit 104.

The A/D conversion unit 104 AD-converts the pixel potential 118 read out from the image sensor unit 103 into a digital value. In this embodiment, an analog gain corresponding to each region is set in the A/D conversion unit 104 by the gain control unit 110. The analog gain 121 is the amplification gain value for the pixel potential 118. The A/D conversion unit 104 amplifies the pixel potential 118 output from the image sensor unit 103 by the analog gain 121 determined for each region, and then AD-converts the amplified pixel potential into a digital value. Hereinafter, the image, which is generated from the digital signals that have been analog-to-digital converted by the A/D conversion unit 104 after being amplified by the analog gain 121 set for each region, is referred to as the exposure image 122. The exposure image 122 output from the A/D conversion unit 104 is transmitted to the exposure condition calculator 111 and the exposure compensation unit 105.

Based on the exposure image 122, the exposure condition calculator 111 calculates and updates, for each region, the exposure time period 112 and the analog gain value 113 to set an appropriate conditions for image capturing (region-based exposure control). For example, the exposure condition calculator 111 acquires a histogram of pixel values for each pixel block based on the luminance distribution of the exposure image 122. If the pixel values are distributed on the bright side, the exposure condition calculator 111 changes (updates) the exposure time period 112 and the analog gain value 113 corresponding to this pixel block (region) to setting values for darker image capturing. If the pixel values are distributed on the dark side, the exposure condition calculator 111 changes (updates) the exposure time period 112 and the analog gain value 113 corresponding to this pixel block (region) to setting values for brighter image capturing. The value of the exposure time period 112 for each region is transmitted to the exposure time period control unit 109 and the exposure compensation unit 105. The analog gain value 113 for each region is transmitted to the gain control unit 110 and the exposure compensation unit 105.

The synchronization control unit 101 generates an exposure time period output pulse 120 and a gain output pulse 114, which are synchronized. The synchronization control unit 101 outputs the generated exposure time period output pulse 120 to the exposure time period control unit 109. The synchronization control unit 101 outputs the generated gain output pulse 114 to the gain control unit 110. Thus, the synchronization control unit 101 performs synchronization control between the processing of the exposure time period control unit 109 and the processing of the gain control unit 110.

The exposure time period output pulse 120 is a signal for controlling the timing at which the exposure time period control unit 109 outputs the exposure control signal 117 to the image sensor unit 103. The exposure time period control unit 109 outputs the exposure control signal 117 to the image sensor unit 103 based on the exposure time period output pulse 120, thereby changing the exposure time period for each pixel block of the image sensor unit 103.

The gain output pulse 114 is a signal for controlling the timing at which the gain control unit 110 outputs the analog gain 121 to the A/D conversion unit 104. The gain control unit 110 outputs the analog gain 121 to the A/D conversion unit 104 based on the gain output pulse 114, thereby changing, for each pixel block, the gain used to amplify the pixel potential of the signal output from each pixel. In this manner, in this embodiment, the synchronization control unit 101 synchronizes and controls operations of the exposure time period control unit 109 and the gain control unit 110. Accordingly, it is possible to output the exposure image 122 in which the exposure time period and analog gain are changed for each pixel block of the image sensor unit 103.

Based on the exposure time period output pulse 120 and the value of the exposure time period 112 for each region, the exposure time period control unit 109 generates the exposure control signal 117 for each region, and outputs it to the image sensor unit 103. With this, the exposure time period corresponding to the exposure time period 112 for each region is set in the image sensor unit 103 at the appropriate timing.

In accordance with the timing of the gain output pulse 114, the gain control unit 110 outputs, to the A/D conversion unit 104, the analog gain value 113 for each region as the analog gain 121 for each region corresponding to the pixel potential 118 for each region of the image sensor unit 103. With this, in the A/D conversion unit 104, the pixel potential 118 for each region is amplified by the analog gain 121 for each region corresponding to the region and then AD-converted. The AD-converted data is transmitted as the exposure image 122 for each region to the exposure compensation unit 105 and the exposure condition calculator 111.

For the exposure image 122 for each region transmitted from the A/D conversion unit 104, the exposure compensation unit 105 accumulates the exposure images 122 captured in the same frame while changing the exposure condition, performs necessary processing, and then executes an addition process for each pixel. On the image having undergone the addition process, the exposure compensation unit 105 further performs tone expansion processing based on the exposure time period 112 and the analog gain value 113, thereby generating a tone-expanded image 123. From the exposure image 122 for each region represented by, for example, 10 bits, the exposure compensation unit 105 generates the tone-expanded image 123 represented by 23 bits. The detailed operation of the exposure compensation unit 105 will be described later. The generated tone-expanded image 123 is transmitted to the tone conversion unit 106.

The tone conversion unit 106 performs tone conversion on the tone-expanded image 123, and outputs a tone-converted image 124 to the image output unit 108. In this embodiment, tone conversion is assumed to be processing of generating the for example 12-bit tone-converted image 124 from the 23-bit tone-expanded image 123 by gamma conversion. Note that the tone conversion processing in this embodiment is performed to suppress the data rate in the subsequent processing. In this embodiment, the exposure image 122 and the tone-converted image 124 have a 10-bit length and a 12-bit length, respectively. However, these bit lengths are merely examples, and the present disclosure is not limited thereto.

The image output unit 108 outputs the tone-converted image 124 to the subsequent-stage configuration of the image capturing apparatus 100 or to the outside. In this embodiment, the controller 10 is connected as a processing module for receiving the image data from the image capturing apparatus 100. Here, for the output signal line 12 connecting the image output unit 108 and the controller 10, an LVDS signal line having 16 data channels can be used. However, the kind and data channel width of the output signal line 12 are not limited by this embodiment.

The controller 10 is also connected to the serial input/output interface (SIO I/F) 141 of the image capturing apparatus 100 via the serial communication line 11. The SIO I/F 141 is connected to the register 142, and the controller 10 can set necessary information in the register 142 in the image capturing apparatus 100 via the SIO I/F 141. The information set in the register 142 is transmitted to the exposure condition calculator 111 to enable control of calculation of the exposure condition.

FIG. 2 is a view for explaining an example of the configuration of the image sensor unit 103. The imaging region of the image sensor unit 103 includes a plurality of pixel blocks 201. The pixel block 201 further includes a plurality of pixels 202. In this embodiment, 2,000 pixels are arranged in the direction of a width 206 (the horizontal line direction) of the imaging region of the image sensor unit 103, and 1,000 pixels are arranged in the direction of a height 205 (that is, 1,000 horizontal lines are provided in the vertical direction). In addition, 100 pixels are arranged in the direction of a width 204 (horizontal line direction) of one pixel block 201, and 100 pixels are arranged in the direction of a height 203 (corresponding to 100 horizontal lines in the vertical direction). In this case, in the imaging region of the image sensor unit 103, 20 pixel blocks 201 are arranged in the horizontal direction, and 10 pixel blocks 201 are arranged in the vertical direction. Note that these numbers of pixels and lines are merely examples, and the present disclosure is not limited thereto.

The notations “pixel block [0, 0]” to “pixel block [19, 9]” written in the respective pixel blocks 201 shown in FIG. 2 indicate the positions of the respective pixel blocks 201 in the imaging region. The values in brackets [ ] represent the horizontal and vertical indices of each pixel block in the imaging region. In FIG. 2, for example, the pixel block 201 located at the upper right of the image sensor unit 103 is represented as the pixel block [19, 0]. A set of pixel blocks represented by the same vertical index is referred to as a block row.

That is, a block row N is constituted by pixel blocks [0, N] to [19, N]. For example, the block row 5 is constituted by pixel blocks [0, 5] to [19, 5]. Note that the sizes (the numbers of pixels in the vertical and horizontal directions) of the image sensor unit 103 and the pixel block 201 are not limited to the examples described above. The shape and aspect ratio of the pixel 202 are also not limited. The shape of the pixel may be, for example, rectangular rather than square. Furthermore, the pixel block 201 may be constituted by only one pixel 202. In this embodiment, the exposure time period and the analog gain can be controlled for each pixel block 201.

Here, the exposure time period corresponds to the time period during which charges are accumulated in the pixel (light receiving element) of the image sensor unit 103 during image capturing. Accordingly, for example, if the quantity of incident light on the image sensor unit 103 is the same and the pixels are not saturated, the longer the exposure time period, the higher the pixel potential 118, and a brighter image can be captured. That is, if the quantity of incident light is the same and pixel saturation is not taken into consideration, for example, when comparing an exposure time period of 1/480 sec with an exposure time period of 1/30 sec, a brighter image can be captured with the exposure time period of 1/30 sec.

The analog gain is a gain used to amplify the pixel potential 118 before A/D conversion in the A/D conversion unit 104 during image capturing. Accordingly, the larger the analog gain value, the higher the input to the A/D conversion unit 104, and therefore the larger the digital value output from the A/D conversion unit 104.

Referring back to FIG. 1, the configuration and driving method of the image capturing apparatus 100 according to this embodiment will be described. The image sensor unit 103 performs image capturing while the exposure time period for each pixel block 201 is controlled based on the exposure control signal 117. Then, the image sensor unit 103 outputs the pixel potential 118 corresponding to the charges accumulated for each pixel.

The A/D conversion unit 104 uses the analog gain 121 set for each pixel block of the image sensor unit 103 to amplify the pixel potential 118 output from the image sensor unit 103. After that, the A/D conversion unit 104 performs digital conversion, and outputs the exposure image 122. Note that in this embodiment, the exposure image 122 is assumed to have a 10-bit digital value. The analog gain 121 can take four gain values of, for example, ×1, ×2, ×4, and ×8.

The exposure compensation unit 105 performs, on the exposure image 122 input from the A/D conversion unit 104, tone expansion processing for each region based on the exposure time period 112 and the analog gain value 113, and outputs the tone-expanded image 123. The exposure compensation unit 105 recognizes the image capturing condition of the exposure image 122 for each region from the exposure time period 112 for each region and the analog gain value 113 for each region. Then, the exposure compensation unit 105 compensates for the exposure image 122 for each region based on the image capturing condition of the exposure image 122 for each region.

The exposure compensation unit 105 performs tone expansion processing based on the exposure time period 112 and the analog gain value 113 on the exposure image 122 for each region transmitted from the A/D conversion unit 104, thereby generating the tone-expanded image 123. For example, the exposure compensation unit 105 recognizes the image capturing condition of the exposure image 122, which is input for each region, from the exposure time period 112 for each region and the analog gain value 113 for each region, and compensates for the exposure image 122 for each region in accordance with the condition.

The exposure compensation unit 105 performs tone expansion processing on the exposure image 122 for each region represented by, for example, 10 bits, thereby generating the tone-expanded image 123 represented by 23 bits. Then, the generated tone-expanded image 123 is transmitted to the tone conversion unit 106. For example, the exposure compensation unit 105 recognizes the image capturing condition of the exposure image 122, which is input for each region, from the exposure time period 112 for each region and the analog gain value 113 for each region, and compensates for the exposure image 122 for each region in accordance with the condition.

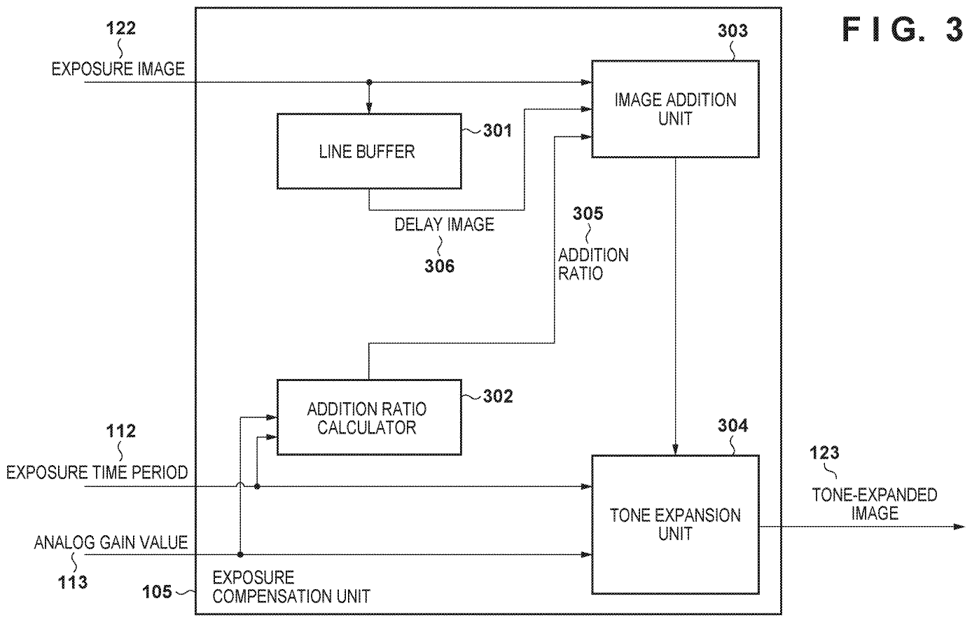

Next, the operation of the exposure compensation unit 105 will be described. FIG. 3 is a block diagram showing an example of the configuration of the exposure compensation unit 105. The exposure compensation unit 105 includes a line buffer 301, an addition ratio calculator 302, an image addition unit 303, and a tone expansion unit 304. The line buffer 301 can be used to delay data and synchronize the timing for later image composition.

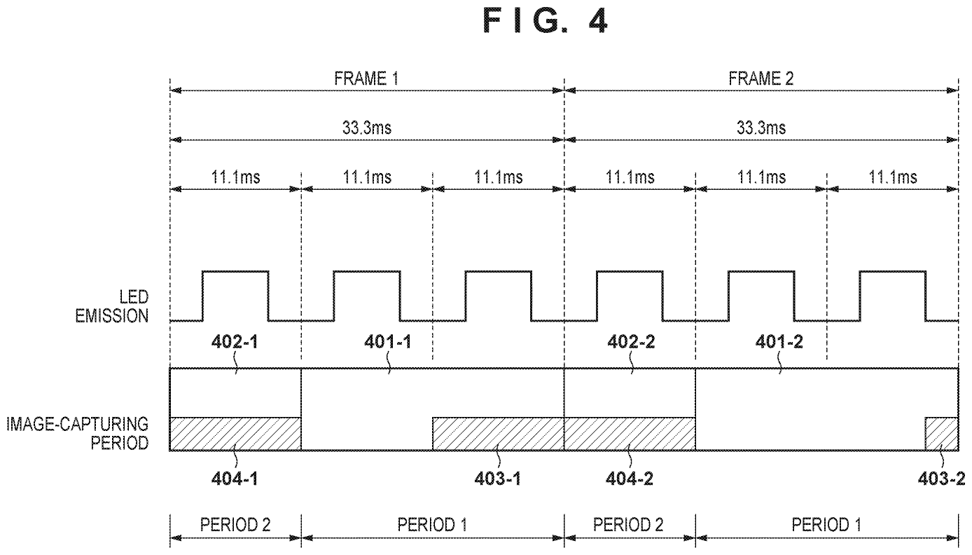

The operation of each component of the exposure compensation unit shown in FIG. 3 will be described with reference to FIG. 4. FIG. 4 is a view showing the relationship between control of the exposure time period and the emission cycle of a light-emitting diode (LED), which is the light-emitting source in the image capturing target, when the LED is assumed to be the periodic light-emitting source in this embodiment.

In this embodiment, assume that the image output frame rate is 30 frames/sec when the image capturing apparatus 100 captures a moving image. At this time, the period of one frame of a moving image is 1/30 sec, and one frame period is about 33.3 ms (to be written as 33.3 ms hereinafter). In addition, assume that the LED included in the image capturing target periodically emits light with an emission cycle of 90 Hz and a duty ratio of 50%. For the sake of descriptive convenience, FIG. 4 shows a frame 1 and a frame 2, which are temporally consecutive. The image-capturing period of the frame 1 is divided into a period 402-1 and a period 401-1. The period 402-1 has the length of a period 2, which is a predetermined period set to be equal to or longer than the emission cycle of the LED. In this embodiment, the predetermined period has the same length as the emission cycle of the LED, which is 1/90 sec (which is about 11.1 ms, and will be written as 11.1 ms hereinafter). Reference numeral 404-1 denotes the exposure time period of the image sensor in the period 2. In the period 2, the exposure time period of the image sensor is always set across the entire period 2.

As can be seen from FIG. 4, since the period 2 is set to be equal to or longer than the emission cycle of the LED, the period 2 includes the period (indicated by a protruding part in the “LED emission” field in FIG. 4) during which the LED emits light. A period 1 corresponding to the period 401-1 is the image-capturing period of the frame 1 excluding the period 402-1. The period 1 corresponding to the period 401-1 is a period during which region-based exposure control is performed in accordance with the brightness of the image capturing target. Reference numeral 403-1 denotes the exposure time period, which is set by the region-based exposure control in the period 401-1. In this embodiment, the exposure time period 403-1 is half of the period 401-1. Similar control is performed for the frame 2 following the frame 1. In the frame 2, an exposure time period 403-2 in the period 1 is set to ⅛ of a period 401-2 as a result of region-based exposure control. Hence, in FIG. 4, the light emission period of the LED is not captured by the image sensor in the exposure time period 403-2. If the light emission period of the LED is not captured by the image sensor, flickering can occur in the captured moving image.

The exposure time periods of the image sensor in the period 1 and the period 2 are controlled by the exposure time period control unit 109 based on the exposure time period 112 determined by the exposure condition calculator 111 shown in FIG. 1. For the length of the period 2, the exposure condition calculator 111 can use the value set in the register 142 by the external controller 10 as the emission cycle of the LED subject to flicker prevention. The exposure time period in the period 1 can be calculated based on an algorithm for calculating the exposure condition for region-based exposure, and based on the exposure image 122 in the period 1 of the immediately preceding frame. Note that the length of the period 2 can be determined in accordance with the region where this image capturing apparatus will be used as a product, and can be set in advance in the register 142 by the external controller 10. It is also possible that the destination is determined using location information such as GPS and, when the image capturing apparatus is started up, the external controller 10 refers to a table corresponding to the location information and sets the data in the register 142.

In FIG. 3, the exposure image 122 in the period 2 of the frame 1 shown in FIG. 4 is first input to the exposure compensation unit 105. Here, the image data of the exposure image 122 in the period 2 of a given frame at a given pixel position is referred to as image data O₂. After the period 2 has elapsed, the image data O₂ is first stored in the line buffer 301. After the period 1 has elapsed, the exposure image 122 in the period 1 of the frame 1 is input. The image data of the exposure image 122 in the period 1 of the same frame 1 at this time is referred to as image data O₁.

At the time when the image data O₁ is supplied to the exposure compensation unit 105 as the exposure image 122, the image addition unit 303 reads out the image data O₂ from the line buffer 301 as a delayed image 306. In this case, the length of the data holding period in the line buffer 301 is equal to the length of the period 1. A composite output O₃, which is a composite image signal of the image data O₁ and the image data O₂, is calculated based on the following equation (1) and an addition ratio k 305 calculated by the addition ratio calculator 302. Here, the addition ratio k 305 is a value for compensating for the image data O₁ and the image data O₂ by performing weighted addition based on the respective image capturing conditions.

O₃=O₁+k×O₂ (1)

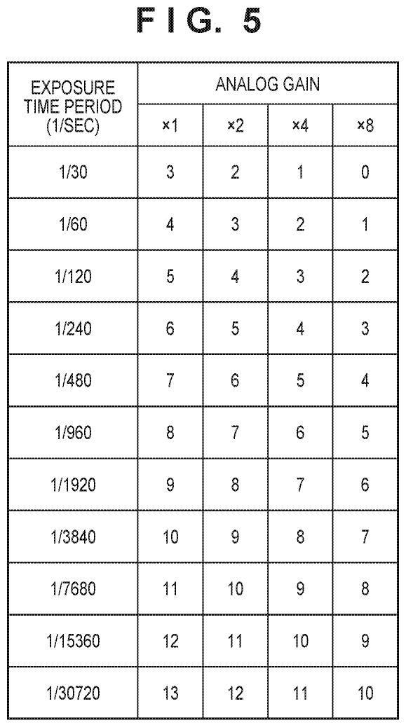

Next, the method of calculating the addition ratio k 305 by the addition ratio calculator 302 will be described with reference to FIG. 5. FIG. 5 is a table showing the relationship among the exposure condition, the exposure time period, and the analog gain in region-based exposure control. This table is applied when the frame rate is 30 fps, and shows the relationship between the exposure time period and the analog gain for the entire one frame period. In FIG. 5, the analog gain is shown along the horizontal axis and the exposure time period along the vertical axis, and the number at their intersection is referred to as an EV value. The EV value is a power-of-two value that represents the ratio of brightness of an image capturing target based on the difference in exposure condition when the pixel signal level (pixel value) obtained by image capturing is the same. Assuming that the brightness of the image capturing target captured with an analog gain of ×8 and the exposure time period of 1/30 sec is L0, a brightness LE of the image capturing target when the same pixel value is obtained by capturing it with an EV value E can be expressed by:

LE=L0×2\hat{ }E (2)

For example, when the analog gain is ×1 and the exposure time period is 1/30 sec, the EV value is 3. Similarly, when the analog gain is ×1 and the exposure time period is 1/60 sec, the EV value is 4. This indicates that when the pixel values obtained by image capturing are the same, the image capturing target captured under the condition with the EV value of 4 is twice as bright as the image capturing target captured under the condition with the EV value of 3.

Note that in the region-based exposure, the table as shown in FIG. 5 is used to estimate the brightness of the image capturing target in a given region from the pixel value obtained in image capturing in the preceding frame and the exposure condition used in the image capturing, and the exposure condition to be used for image capturing in the next frame can be calculated.

Here, assume that the exposure condition used in the period 402-1 in FIG. 4 is that the analog gain is ×1 and the exposure time period is fixed to the entire period 2. If this exposure condition is applied to the entire frame, the exposure time period is 1/30 sec, which corresponds to the entire frame, and the EV value in this case is 3 as shown in FIG. 5. On the other hand, in the exposure condition used in the period 401-1, the exposure time period is half of the period 1. If this exposure condition is similarly applied to the entire frame, the exposure time period is 1/60 sec, which corresponds to half of the entire frame. In this case, if the analog gain is ×4, the EV value is 2 as shown in FIG. 5.

This means that under the condition where it is originally determined appropriate to use an EV value of 2 for image capturing according to the region-based exposure, image capturing is performed with an EV value of 3 in the period 402-1. In the tone expansion unit 304 to be described later, the brightness of the pixel value is converted based on the EV value of 2 of the region-based exposure condition. Hence, the value of the image data O₂ captured with the EV value of 3 is converted into a value equivalent to that captured with the EV value of 2, and then added to the image data O₁. Thus, the pixel value for the entire one frame period is obtained. The coefficient for this conversion is k. k can be calculated by:

k=2\hat{ }(EV value in period 2)÷2\hat{ }(EV value in period 1)=2\hat{ }(EV value in period 2−EV value in period 1) (3)

From equation (3), a conversion coefficient k1 in the frame 1 in this embodiment is calculated as:

k1=2\hat{ }(3−2)=2\hat{ }1=2

Similarly, consider the frame 2. The length of the exposure time period 403-2 of the frame 2 is ⅛ the length of the period 1. This corresponds to the exposure time period of 1/240 sec in FIG. 5. At this time, if the analog gain is ×1, the EV value in the time period 401-2 is 6. The EV value in the period 402-2 is 3, which is the same as in the period 402-1. This is because the exposure condition for each period 2 is uniformly set to the same condition. A conversion coefficient k2 in the frame 2 at this time is obtained as:

k2=2\hat{ }(3−6)=2\hat{ }(−3)=⅛

In FIG. 3, the composite output O₃ of the image data O₂ and the image data O₁ calculated based on equation (1) by the image addition unit 303 is transmitted to the tone expansion unit 304. In the tone expansion unit 304, the EV value shown in FIG. 5 is obtained from the exposure time period 112 and the analog gain value 113 of the corresponding pixel block. Letting E be the EV value at this time, the pixel value after tone expansion can be obtained by equation (2).

For example, as described above, the exposure condition in the period 1 of the frame 1 shown in FIG. 4 is that the exposure time period is equivalent to 1/60 sec when the length of the period 1 is converted into the length of the entire frame 1, and the analog gain is ×4. The EV value in this case is 2. Letting O₃₁ be the composite output of the frame 1 after the addition process, and O₄₁ be the pixel value after tone expansion:

O₄₁=O₃₁×2\hat{ }2=4×O₃₁

Similarly, as described above, the exposure condition in the period 1 of the frame 2 shown in FIG. 4 is that the exposure time period is equivalent to 1/240 sec when the length of the period 1 is converted into the length of the entire frame 2, and the analog gain is ×1. The EV value in this case is 6. Letting O₃₂ be the composite output of the frame 2 after the addition process, and O₄₂ be the pixel value after tone expansion:

O₄₂=O₃₂×2\hat{ }6=64×O₃₂

In this case, if the original exposure image of the composite output O₃₂ has a 10-bit width, the pixel value O₄₂ is a 16-bit number as a result of the calculation. In this embodiment, it can be seen from FIG. 5 that the EV value can be 13 at maximum. In that case, by performing tone expansion in the exposure compensation unit 105, the data bit width increases. In this embodiment, the tone-expanded image 123 may have a 23-bit width at maximum. Thereafter, as described above, the tone conversion unit 106 generates, from the 23-bit tone-expanded image 123, for example, a 12-bit tone-converted image 124 by gamma conversion.

According to this embodiment, image processing is performed in which the image data in the period 2 and the image data in the period 1 are appropriately composited in one frame period. With this processing, even if a light source with a blinking period, such as an LED, is present in the image capturing range, it is possible to perform wide dynamic range (WDR) image capturing that takes advantage of the characteristics of region-based exposure while suppressing flicker. For example, as in the frame 2 in FIG. 4, even if the light emission period of the LED cannot be captured in the period 1 in which region-based exposure is performed, light emission of the LED is captured in the period 2. Therefore, in the image of the frame 2 obtained by compositing the output of the period 1 and the output of the period 2, light emission of the LED is captured. This can prevent the image from appearing as if the LED light source is off.

### Second Embodiment

Regarding the control of the exposure time period in one frame period in first embodiment, the period 2, which is set to be equal to or longer than the emission cycle of the LED, is in the first half of the frame, and the period 1, during which region-based exposure control is performed in accordance with the brightness of the image capturing target, is in the second half of the frame, as shown in FIG. 4. However, in a case where the period 1 comes after the period 2 in one frame period, if the period 2 is shorter than the period 1 as in FIG. 4, the period to hold the data of the period 2 in the line buffer 301 shown in FIG. 3 increases, so that the memory amount required for the line buffer 301 increases.

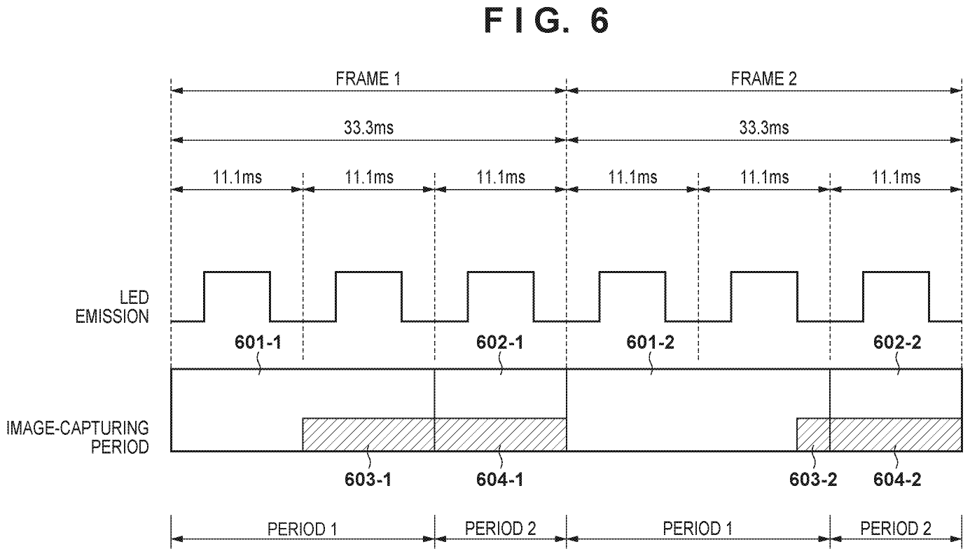

In the second embodiment, a method for, if a period 2 is shorter than a period 1, obtaining an effect similar to that in the first embodiment while decreasing the memory amount required for a line buffer 301 will be described with reference to FIG. 6. Note that matters not mentioned below are similar to those in the first embodiment described above.

FIG. 6 is a view showing, in the second embodiment, the relationship between control of the exposure time period and the emission cycle of an LED in the image capturing target. Unlike in FIG. 4, in FIG. 6, the period 2, which is set to be equal to or longer than the emission cycle of the LED, is in the second half of the frame, and the period 1, during which region-based exposure control is performed in accordance with the brightness of the image capturing target, starts from the beginning of the frame.

In FIG. 6, the image-capturing period of a frame 1 is divided into a period 601-1 and a period 602-1. The period 602-1 has the length of the period 2, which is set to be equal to or longer than the emission cycle of the LED. In this embodiment, as in the first embodiment, the period 2 is 11.1 ms. Reference numeral 604-1 denotes the exposure time period of the image sensor in the period 2. In the period 2, the exposure time period of the image sensor is always set across the entire period 2. As can be seen from FIG. 6, since the period 2 is set to be equal to or longer than the emission cycle of the LED, the period 2 can include the period (indicated by a protruding part in the “LED emission” field in FIG. 6) during which the LED emits light. The period 1 corresponding to the period 601-1 is the image-capturing period of the frame 1 excluding the period 602-1.

The period 1 corresponding to the period 601-1 is a period during which region-based exposure control is performed in accordance with the brightness of the image capturing target. Reference numeral 603-1 denotes the exposure time period for the period 601-1 that is set by the region-based exposure control. In this embodiment, the exposure time period 603-1 is half of the period 601-1. As described above, in the second embodiment, the period 601-1 corresponding to the period 1 is in the first half of the frame, and the period 602-1 corresponding to the period 2 follows the period 1. Similar control is performed for the frame 2. In this example, in the frame 2, an exposure time period 603-2 in the period 1 is set to ⅛ of a period 601-2 as a result of region-based exposure control. Hence, as shown in FIG. 6, the light emission period of the LED is not captured by the image sensor in the period 601-2.

As in the first embodiment, the image data of an exposure image 122 in the period 2 of a given frame at a given pixel position is referred to as image data O₂. The image data of the exposure image 122 in the period 1 of the same frame is referred to as image data O₁. In the second embodiment, as can be seen from FIG. 6, the image data O₁ is first input as the exposure image 122 in FIG. 3. Accordingly, in FIG. 3, the data O₁ of the period 1 is first input to and held in the line buffer 301. The data O₁ is held in the line buffer during the period 2. When the data O₂ of the period 2 is input, a composite output O₃ is calculated based on the above-described equation (1). The following operations are similar to those in the first embodiment.

According to the second embodiment, the length of the holding period of the data O₁ in the line buffer 301 is equal to the length of the period 2. In the first embodiment, the length of the holding period is equal to the length of the period 1. In a case where the period 2 is shorter than the period 1, the data amount held by the line buffer 301 decreases by the amount of length difference between the period 2 and the period 1. Hence, an effect similar to that in the first embodiment can be obtained with a small memory amount.

### Third Embodiment

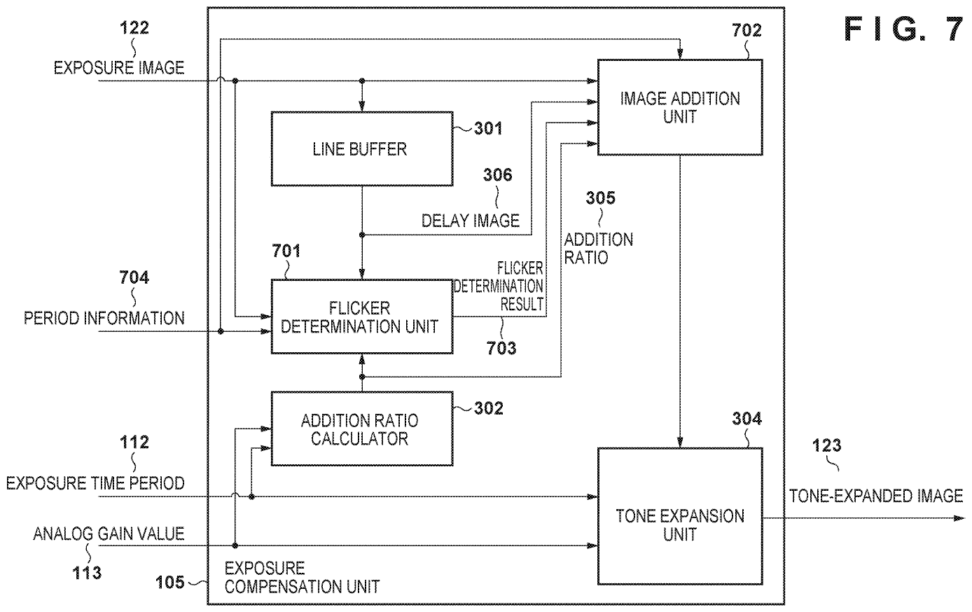

In the first embodiment, the composite image signal generated from the image data of the period 1 and the image data of the period 2 is always output as the image signal. However, since the period 2 is determined regardless of the brightness of the image capturing target, under a condition which is determined to be bright by region-based exposure, the output is easily saturated. In the third embodiment, to address such a case, an example will be described with reference to FIGS. 7 to 10, in which it is determined whether a light source causing flicker is present in the image capturing target, and the composite ratio of the data of a period 1 and the data of a period 2 is adaptively changed. Note that matters not mentioned below are similar to those in the first embodiment described above.

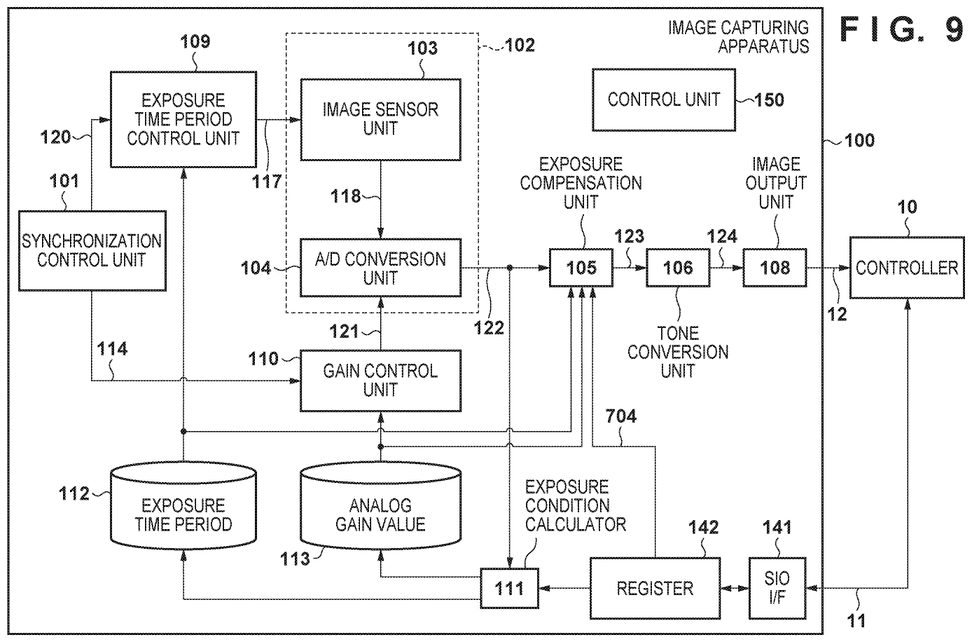

FIG. 7 is a block diagram showing an example of the configuration of the exposure compensation unit 105 in the third embodiment. The exposure compensation unit 105 includes a line buffer 301, an addition ratio calculator 302, a flicker determination unit 701, an image addition unit 702, and a tone expansion unit 304. As shown in FIG. 9, period information 704 is input from the register 142, and used in the flicker determination unit 701 and the image addition unit 702. Components equivalent to those in embodiment 1 are assigned the same reference numerals as in FIG. 3 of embodiment 1.

The operation of each component of the exposure compensation unit 105 shown in FIG. 7 will be described with reference to the example of the image-capturing period shown in FIG. 4. Much of the operation of the exposure compensation unit 105 in the third embodiment is similar to that in the first embodiment, and differences from the first embodiment will be described here.

In FIG. 7, an exposure image 122 in the period 2 of a frame 1 shown in FIG. 4 is first input to the exposure compensation unit 105. In this embodiment as well, the image data of the exposure image 122 in the period 2 of a given frame at a given pixel position is referred to as image data O₂. The data O₂ is first stored in the line buffer 301. After the period 1 has elapsed, the exposure image 122 in the period 1 of the frame 1 is input. The image data of the exposure image 122 in the period 1 of the same frame at this time is referred to as image data O₁. At the time when the image data O₁ is supplied as the exposure image 122, the flicker determination unit 701 reads out the data O₂ from the line buffer 301 as a delayed image 306. Then, based on an addition ratio k 305 calculated by the addition ratio calculator 302, the flicker determination unit 701 determines whether flicker has occurred at this pixel, and transmits a flicker determination result 703 to the image addition unit 702. The operation of the flicker determination unit 701 will be described later.

In the image addition unit 702, the data O₂ read out as the delayed image 306, the data O₁ supplied as the exposure image 122, and the addition ratio k 305 are each delayed by respective times corresponding to the time required for calculating the flicker determination result 703 in the flicker determination unit 701. Then, a composite output O₃ is calculated using the flicker determination result 703. The operation of the image addition unit 702 will be described later.

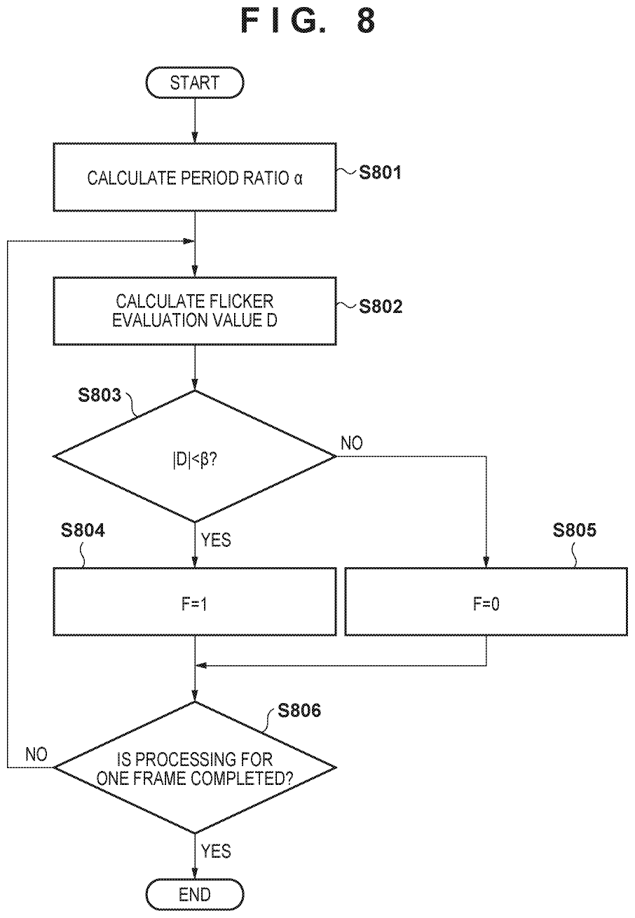

FIG. 8 is a flowchart showing an example of processing for calculating the flicker determination result 703 in the flicker determination unit 701. In step S801, a period ratio α as the ratio of the period 1 and the period 2 is calculated. The ratio of the period 1 and the period 2 is calculated based on the period information 704 input from the register 142. The period ratio α can be calculated by:

α=(length of period 1)÷(length of period 2) (4)

In the third embodiment, the length of the period 1 is 22.2 ms and the length of the period 2 is 11.1 ms from the example shown in FIG. 4, thereby the period ratio α=2. Calculation of the period ratio α in step S801 is performed first for each frame.

Using the period ratio α calculated as described above and the addition ratio k, the values of the image data O₁ and the image data O₂ are compensated. Using the first compensated signal obtained by compensating for the image data O₁ and the second compensated signal obtained by compensating for the image data O₂, a flicker evaluation value D is calculated for each pixel in step S802. Using the image data O₁, the image data O₂, the addition ratio k calculated by the addition ratio calculator 302, and the period ratio α, the flicker evaluation value D can be calculated by:

D=O₁÷k−α×O₂ (5)

From equation (5), the difference between the first compensated signal obtained by compensating for the image data O₁ with the addition ratio k and the second compensated signal obtained by compensating for the image data O₂ with the period ratio α is calculated as the flicker evaluation value D. Then, in step S803, it is determined for each pixel whether flicker has occurred. Here, β is a threshold for determining whether flicker has occurred. If the absolute value of the flicker evaluation value D calculated in step S802 is smaller than the threshold β, it is determined that no flicker has occurred (YES in step S803), and the processing advances to step S804; otherwise, it is determined that flicker has occurred (NO in step S803), and the processing advances to step S805.

In the third embodiment, the threshold β is a predetermined threshold given in advance, and set in the flicker determination unit 701. However, the method of setting the threshold β is not limited to this, and it is also possible to change and use the value as needed by, for example, setting it in the register 142 from the external controller 10, similar to the period information 704. The flicker evaluation value D is compared with the threshold β to determine whether the flicker evaluation value D is smaller than the threshold β.

In step S804, a flicker determination result F is set F=1, which means that no flicker has occurred. The value of F is transmitted to the image addition unit 702 as the flicker determination result 703. On the other hand, in step S805, as the value of F indicating the flicker determination result, F=0 is set to indicate that flicker has occurred. In this case as well, the value of F is transmitted to the image addition unit 702 as the flicker determination result 703.

In step S806, it is determined whether the calculation processing of the flicker evaluation value D is completed for pixels of one frame. If the calculation processing is not completed for pixels of one frame (NO in step S806), the processing from step S802 is repeated. If the calculation processing is completed (YES in step S806), the processing is terminated.

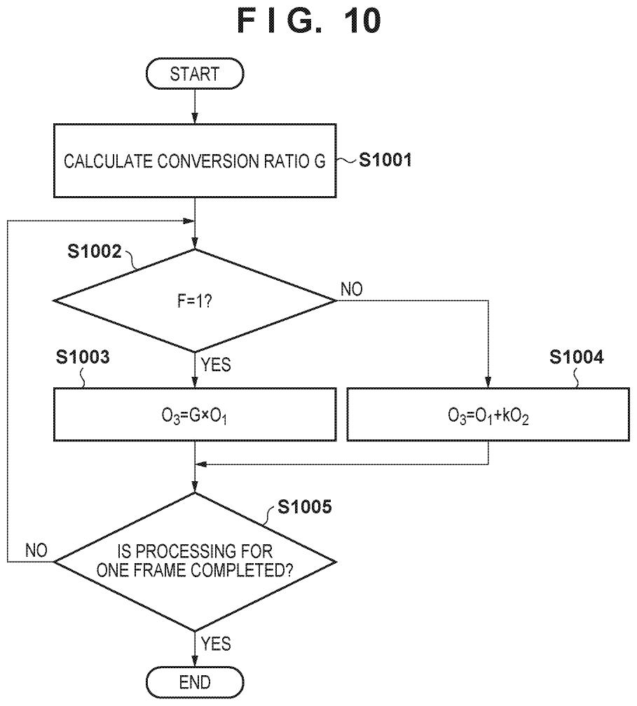

FIG. 10 is a flowchart showing an example of image addition processing in the image addition unit 702 according to whether flicker has occurred. In step S1001, a conversion ratio G, which is used in step S1003, is calculated. The conversion ratio G is a coefficient for converting the output value O₁, which is obtained according to region-based exposure control, into the pixel value in the frame in a case where it is determined that there is no flicker. Using the length of the period 1 and the length of the period 2 based on the period information 704 input from the register 142, the conversion ratio G can be obtained by:

G={(length of period 1)+(length of period 2)}÷(length of period 1) (6)

In the third embodiment, the length of the period 1 is 22.2 ms and the length of the period 2 is 11.1 ms as shown in FIG. 4, thereby G=(22.2+11.1)÷22.2=1.5. Calculation of the conversion ratio G in step S1001 may be performed first for each frame.

Then, in step S1002, referring to the flicker determination result F for each pixel, a calculation method of the pixel value O₃ to be output is determined. If F=1 and no flicker has occurred (YES in step S1002), the processing advances to step S1003. On the other hand, if F=0 so that flicker has occurred at this pixel (NO in step S1002), the processing advances to step S1004.

In step S1003, the pixel value O₃, which is to be output in a case where no flicker has occurred, is calculated using equation (7) described below. Then, the processing advances to step S1005.

O₃=G×O₁ (7)

In step S1004, the pixel value O₃, which is to be output in a case where flicker has occurred, is calculated using equation (1) described in the first embodiment. Then, the processing advances to step S1005. In step S1005, it is determined whether the calculation processing of the pixel value O₃ is completed for pixels of one frame. If the calculation processing is not completed (NO in step S1005), the processing from step S1002 is repeated. If the calculation processing is completed (YES in step S1005), the processing is terminated.

According to the third embodiment, by determining whether a light source causing flicker is present in the image capturing target and adaptively changing the composite ratio of the period 1 and the period 2 in accordance with the determination result, it is possible to obtain an image that is more suitable as a WDR image. Needless to say, the method presented in the third embodiment is also applicable to the case wherein the period 2 is in the second half of the frame as described in the second embodiment.

### Fourth Embodiment

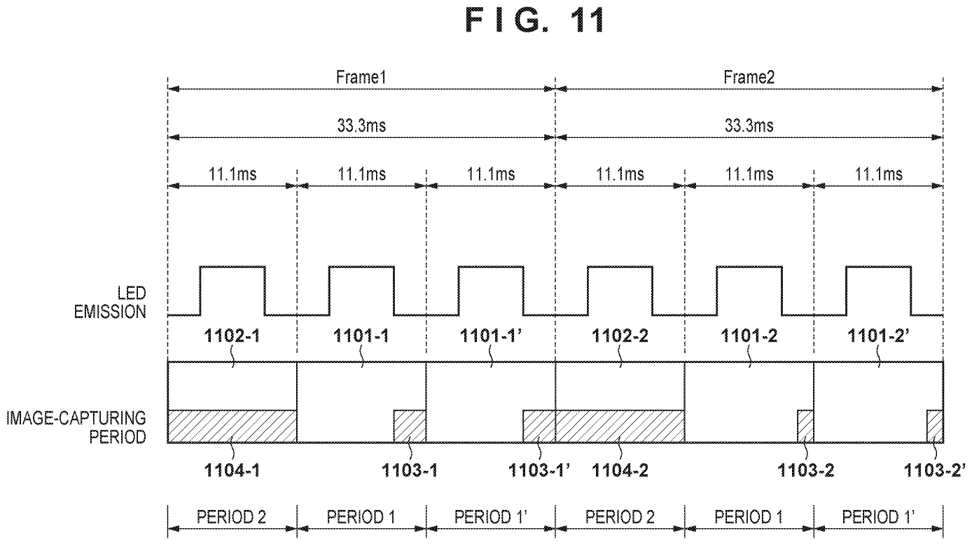

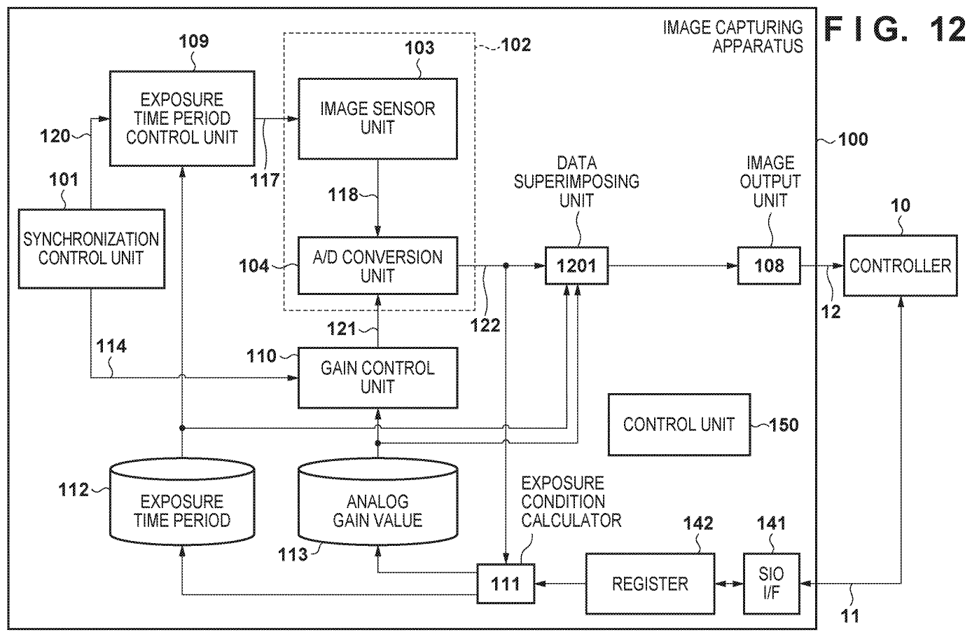

In the first to third embodiments, the output of the period 1 and the output of the period 2 are composited in the image capturing apparatus 100. However, the compositing processing is not necessarily limited to be performed in the image capturing apparatus 100. For example, the compositing processing can be performed in the controller 10 connected to the image capturing apparatus 100. This case will be described with reference to FIGS. 11 and 12.

FIG. 11 is a view showing the relationship between image output and the generated frame image in this embodiment. Here, assume that the user needs a moving image of 30 fps, and the emission cycle of an LED corresponds to 90 Hz. In this example, the image capturing apparatus 100 divides one frame period into three periods to generate three subframes, and outputs the subframes to a subsequent controller 10. In FIG. 11, the subframes are shown as a period 1, a period 1′, and a period 2. For the image capturing apparatus 100, the output operation of the subframe is not different from the operation for image capturing at 90 fps.

FIG. 12 is a block diagram showing an example of the schematic configuration of the image capturing apparatus 100 to which an image capturing control apparatus according to this embodiment is applied, and its connection with the controller 10. The fourth embodiment is different from the first embodiment in that the exposure compensation unit 105 and the tone conversion unit 106 are not provided, and a data superimposing unit 1201 is provided instead. The data superimposing unit 1201 superimposes information indicating the exposure time period 112 and the analog gain value 113 used for image capturing of each pixel block in a blanking period of the image data captured by the image sensor 102, and transmits the image data with the superimposed information to the controller 10 via an LVDS signal line. Note that the information may be communicated between the controller 10 and the image capturing apparatus 100 using separately provided wired or wireless communication, rather than being superimposed on the image data.

In this embodiment, region-based exposure control can be performed on a subframe basis. The exposure condition used in the same subframe as the data of the exposure image is output to the controller 10. In the controller 10, the image is compensated with reference to the exposure condition superimposed on the image of each subframe. By compositing the compensated images, a frame image of 30 fps can be generated.

Referring back to FIG. 11, one frame in FIG. 11 is constituted by three subframes: the subframe period 1 and the subframe period 1′, in each of which region-based exposure control is performed, and the subframe period 2 in which the entire subframe period is set as the exposure time period. The subframe period 1 of the frame 1 is shown as a period 1101-1, and the subframe period 1 of the frame 2 is shown as a period 1101-2. The subframe period 1′ of the frame 1 is shown as a period 1101-1′, and the subframe period 1′ of the frame 2 is shown as a period 1101-2′. Similarly, the subframe period 2 of the frame 1 is shown as a period 1102-1, and the subframe period 2 of the frame 2 is shown as a period 1102-2. Here, for each frame, the length of the exposure time period is the same between the subframe period 1 and the subframe period 1′. That is, a period 1103-1 and a period 1103-1′ have the same length, and a period 1103-2 and a period 1103-2′ have the same length.

Since the exposure condition is calculated for each frame, the exposure time periods in the subframe period 1 and the subframe period 1′ may be different between the frame 1 and the frame 2. FIG. 11 of the present embodiment shows a case in which the exposure time period is different between the frame 1 and the frame 2. On the other hand, the exposure time period (1104-1 or 1104-2) in the period 2 is equal to the length of the period 2, regardless of the frame. Each module in the image capturing apparatus 100 executes control so that charges exposed and accumulated based on the exposure condition as described above in each subframe are output. Details of the control are similar to those described in the first embodiment, and a detailed description will be omitted. The controller 10 receives the image data of the subframes, which are obtained by dividing each frame into three subframes with different exposure conditions, and adds the exposure data of the period 1 and the exposure data of the period 1′ for each pixel. Then, the combined data of the period 1 and the period 1′, and the data of the period 2 are compensated using the method described in the above-described first to third embodiments, by referring to the exposure condition data superimposed on each frame. This makes it possible to generate a high-quality WDR image while reducing the influence of flicker on the captured image.

As has been described above, according to the fourth embodiment, it is possible to composite the outputs of the period 1 and the output of the period 2 not in the image capturing apparatus 100 but in an external controller or the like. In addition, the period 1 is divided into two subframe periods, and the exposure condition can be controlled for each region in two subframe periods.

### Application of Image Capturing Apparatus to Equipment

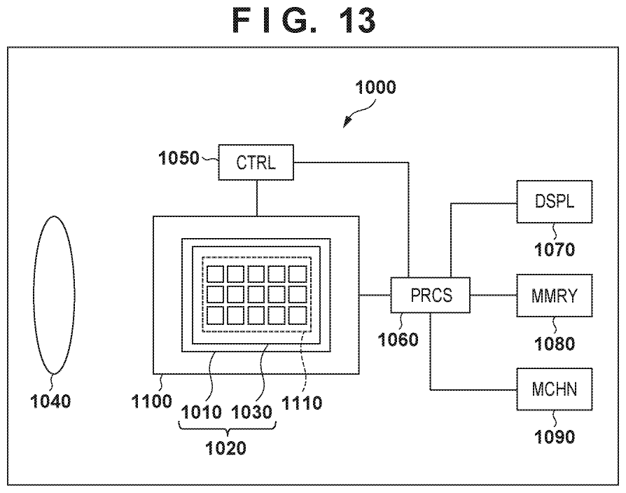

The following is a description of equipment 1000 that includes a semiconductor apparatus 1100 including a package 1020 on which a semiconductor chip 1110 including a semiconductor integrated circuit is mounted, as shown in FIG. 13. The semiconductor chip 1110 is accommodated in the package 1020 and mounted on the equipment 1000. In the arrangement shown in FIG. 13, the semiconductor chip 1110 includes the image capturing apparatus according to the above-described embodiment. The semiconductor apparatus 1100 can include the package 1020 including a base 1010 on which the semiconductor chip 1110 is fixed and a light transmissive member 1030 such as glass that faces the semiconductor chip 1110. The package 1020 can be provided with joining members such as wires and bumps that connect inner leads provided on the base 1010 to terminals such as pad electrodes provided on the semiconductor chip 1110.

The equipment 1000 can include at least one of an optical apparatus 1040, a control apparatus 1050, a processing apparatus 1060, a display apparatus 1070, a storage apparatus 1080, and a mechanical apparatus 1090. The optical apparatus 1040 is implemented by, for example, a lens, a shutter, and a mirror. The control apparatus 1050 controls the semiconductor chip 1110. The control apparatus 1050 is, for example, a semiconductor device such as an ASIC.

The processing apparatus 1060 processes an output signal from the image capturing apparatus included in the semiconductor chip 1110. The processing apparatus 1060 is a semiconductor device such as a CPU or an ASIC for forming an Analog Front End (AFE) or a Digital Front End (DFE). The processing apparatus 1060 may generate an image based on, for example, an event signal E (not shown). The display apparatus 1070 is an EL display device or a liquid crystal display device that displays an image obtained by the semiconductor chip 1110. The storage apparatus 1080 is a magnetic device or a semiconductor device that stores the images obtained by the semiconductor chip 1110. The storage apparatus 1080 is a volatile memory such as an SRAM or a DRAM, or a nonvolatile memory such as a flash memory or a hard disk drive.

The mechanical apparatus 1090 includes a moving or propulsion unit such as a motor or an engine. In the equipment 1000, the signal output from the semiconductor chip 1110 is displayed on the display apparatus 1070 or transmitted to an external apparatus by a communication apparatus (not shown) included in the equipment 1000. Hence, the equipment 1000 may further include the storage apparatus 1080 and the processing apparatus 1060 in addition to the memory circuits and arithmetic circuits included in the semiconductor chip 1110. The mechanical apparatus 1090 may be controlled based on the signal output from the semiconductor chip 1110.

In addition, the equipment 1000 is suitable for electronic equipment such as information terminals having an image capturing function, for example, a smartphone or a wearable terminal, and cameras, including interchangeable lens cameras, compact cameras, video cameras, and monitoring cameras. The mechanical apparatus 1090 in the camera can drive the components of the optical apparatus 1040 in order to perform zooming, a focus operation, and a shutter operation. In addition, the mechanical apparatus 1090 in the camera can move the optical apparatus 1040 in order to perform an anti-vibration operation.

Furthermore, the equipment 1000 can be transportation equipment such as a vehicle, a ship, or an airplane. The mechanical apparatus 1090 in the transportation equipment can be used as a moving apparatus. The equipment 1000 as the transportation equipment is suitable for an apparatus that transports the semiconductor chip 1110 or an apparatus that uses an image capturing function to assist and/or automate drive operation. The processing apparatus 1060 for assisting and/or automating drive operation can perform, based on the information obtained by the semiconductor chip 1110, processing for operating the mechanical apparatus 1090 as a moving apparatus. Alternatively, the equipment 1000 may be medical equipment such as an endoscope, measurement equipment such as a distance measurement sensor, analysis equipment such as an electron microscope, office equipment such as a copy machine, or industrial equipment such as a robot.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An image capturing control apparatus that causes an image sensor, which includes a plurality of pixel blocks each including a plurality of pixels, to capture a moving image, the apparatus comprising
a control unit configured to control the image sensor such that one frame period in the moving image includes: a first image-capturing period including a charge accumulation time period controlled based on a first exposure condition determined for each of the plurality of pixel blocks; and a second image-capturing period including a charge accumulation time period based on a predetermined second exposure condition.

2. The apparatus according to claim 1, wherein
the second image-capturing period is sandwiched between the first image-capturing periods respectively included in temporally consecutive frames.

3. The apparatus according to claim 1, wherein
in the one frame period, the second image-capturing period is set after the first image-capturing period.

4. The apparatus according to claim 1, wherein
the second image-capturing period is set longer than an emission cycle of light-emitting source that is included in an image-capturing target and periodically emits light.

5. The apparatus according to claim 1, wherein
each of the first exposure condition and the second exposure condition includes the charge accumulation time period and a gain which is used to amplify an image signal obtained from the image sensor.

6. The apparatus according to claim 1, wherein the one frame period includes two first image-capturing periods.

7. An image processing apparatus that processes an image signal captured by the image sensor controlled by an image capturing control apparatus according t o claim 1, wherein
the image processing apparatus, for each pixel, performs weighted addition at a predetermined ratio on a first image signal captured in the first image-capturing period and a second image signal captured in the second image-capturing period in the one frame period, thereby generating a composite image signal.

8. The image processing apparatus according to claim 7, wherein
the predetermined ratio is based on the first exposure condition and the second exposure condition.

9. The image processing apparatus according to claim 7, wherein
the predetermined ratio is determined by comparing, a difference between first compensated signal, which is obtained by compensating for the first image signal of a pixel at a predetermined position based on the first exposure condition, and a second compensated signal, which is obtained by compensating for the second image signal of the pixel at the predetermined position based on the second exposure condition, with a threshold.

10. The image processing apparatus according to claim 9, wherein
in a case where the difference is smaller than the threshold, the ratio of t second image signal in the weighted addition is set to 0.

11. An image capturing apparatus comprising an image capturing control apparatus according to claim 1, an image processing apparatus according to claim 7, and the image sensor.

12. A method for driving an image sensor, which includes a plurality of pixel blocks each including a plurality of pixels, to capture a moving image, the method comprising:
driving the image sensor to perform image capturing in a first image-capturing period included in one frame period of the moving image, the first image-capturing period including a charge accumulation time period controlled based on an exposure condition for each of the plurality of pixel blocks; and
driving the image sensor to perform image capturing in a second image-capturing period included in the one frame period, the second image-capturing period including a predetermined charge accumulation time period.

13. A non-transitory computer-readable storage medium storing a program for causing a computer to execute the method according to claim 12.

14. Equipment comprising:
an image capturing apparatus according to claim 11; and
a processing apparatus configured to process a signal output from the image capturing apparatus.
